(19) United States
(12) Patent Application Publication
(10) Pub. No.: US 2018/0143951 A1
(43) Pub. Date: May 24, 2018

(54) AUTOMATIC CREATION OF HIERARCHICAL DIAGRAMS

(71) Applicant: Kong Ping Oh, Troy, MI (US)

(72) Inventor: Kong Ping Oh, Troy, MI (US)

(21) Appl. No.: 15/356,936

(22) Filed: Nov. 21, 2016

(51) Int. Cl. G06F 17/22; G06T 11/20; G06F 17/27; G06F 17/30

(52) U.S. Cl. CPC G06F 17/2241; G06T 11/206; G06F 17/2247; G06F 17/30911; G06F 17/30572; G06F 17/30961; G06F 17/272

(57) ABSTRACT

A hierarchical diagram representing a system with a plurality of components may be created programmatically with a reduced number of human actions. The creation of diagrams to depict relationships and sequences of events may be facilitated. A processor may receive data relating to the system. The received data may be parsed to determine a plurality of elements representing the components. Respective levels in a hierarchy may be associated with the determined elements and the components. The processor may provide an electronic canvas and a plurality of shape objects within the electronic canvas based on the hierarchy. The shape objects may represent the components. Parent-child relationships between the components of the system represented by the shape objects may be determined. The electronic canvas may be used to programmatically define connections between the shape objects that represent the determined parent-child relationships.

### TECHNICAL FIELD

The disclosure relates generally to computer-implemented modeling of systems. More particularly, the disclosure relates to user interfaces and methods for creation of hierarchical diagrams.

### BACKGROUND

A hierarchical diagram may be used to show parent-child relationships between entities. For example, an organization chart may show the reporting structure from employees to mid-management to upper management. Entities in a hierarchical diagram can represent a variety of real world or conceptual entities. Entities may represent organizational units, family members, ideas, bills of materials, and/or the like.

For large collections of entities, it may not be practical to show the entire diagram on a single sheet. For example, the organization chart of a large corporation may be broken down into departmental organization charts, each of which may be an entity of the organization chart at the next level down.

Hierarchical diagrams may be used in engineering and information technology. In recent years, they have been used in standards such as Unified Modeling Language (UML) and System Modeling Language (SysML) to represent a wide variety of ideas and concepts. For example, FIG. 1 illustrates an example hierarchical diagram 100 including shape objects 102, 104, 106, 108, 110, 112 that may represent vehicle system energy management requirements as being composed of fuel economy, driving range, and emission. A fuel economy entity may be further decomposed into highway driving and combined city and highway driving. With respect to the hierarchical diagram shown in FIG. 1, the shape objects may be called nodes, and connecting lines may be called paths or edges.

Hierarchical diagrams may be time-consuming to create. Commercial software applications, for example, in the UML/SysML area, can be used to create hierarchical diagrams. However, users of such applications have to draw and connect the nodes manually. This process can take days or even weeks to complete, for example, for a large system.

### SUMMARY

Systems, methods, and instrumentalities are disclosed for creating a hierarchical diagram programmatically. This can be achieved with a reduced number of human actions, e.g., a single click. The creation of diagrams to depict relationships and sequences of events may be facilitated.

A hierarchical diagram representing a system comprising a plurality of components may be created by using a processor to receive data relating to the system. The received data may be parsed to determine a plurality of elements representing the components. Respective levels in a hierarchy may be associated with the determined elements and the components. The processor may provide an electronic canvas and a plurality of shape objects within the electronic canvas based on the hierarchy. The shape objects may represent the components. Parent-child relationships between the components of the system represented by the shape objects may be determined. Lines in the electronic canvas may be used to define connections between the shape objects that represent the determined parent-child relationships.

### BRIEF DESCRIPTION OF THE DRAWINGS

FIG. 1 illustrates an example hierarchical diagram that represents a system.

FIG. 2 illustrates example requirements for a sports car system.

FIG. 3 illustrates an example process for creating a hierarchical diagram.

FIG. 4 illustrates an example model tree.

FIG. 5 illustrates an example containment path indicating a parent-child relationship.

FIG. 6 illustrates an example frame indicating a parent-child relationship.

FIGS. 7A, 7B, and 7C illustrate the use of names to indicate parent-child relationships.

### DETAILED DESCRIPTION

A detailed description of illustrative embodiments will now be described with reference to the various Figures. The following description of various embodiments implemented in a computing device is to be construed by way of illustration rather than limitation. This description is not intended to limit the scope of the disclosure or the applications or uses of the subject matter disclosed in this specification. For example, while various embodiments are described as being implemented in a computing device, it will be appreciated that the principles of the disclosure are applicable to lumped-parameter dynamic system and reliability system simulators operable in other environments, such as a distributed computing environment.

An electronic canvas may be used as the media for drawing and connecting building blocks. Diagramming tools may provide electronic canvases for drawing blocks, including various applications in the Microsoft OFFICE® productivity suite, which may include, for example, the Microsoft EXCEL® spreadsheet environment, the Microsoft WORD® word processing environment, and other applications. A graphics design interface, such as the GDI+ graphics design interface available from Microsoft, may be used to draw rectangles, lines, and other shapes on a computer screen. Regardless of the selected tool, shapes such as rectangles can be used as icons for building blocks. Lines can be used to connect building blocks to represent relationships between connected blocks.

A diagram may be drawn on a display, e.g., an electronic canvas, using a computer program capable of creating and displaying nodes and paths. Commercially available programs that may be used to draw the diagram include, for example, the VISIO® and EXCEL® applications available from Microsoft Corp. The program may have a set of application programming interfaces (APIs). Geometric shapes can be drawn with higher-level function calls. An API may provide access to a spreadsheet for persisting shapes and system data. Accordingly, data may be saved to the spreadsheet with function calls provided by the API. For example, an EXCEL® function call Application.Activesheet.Range(“AI”).value=1 may put the number 1 in the top left cell of the current worksheet.

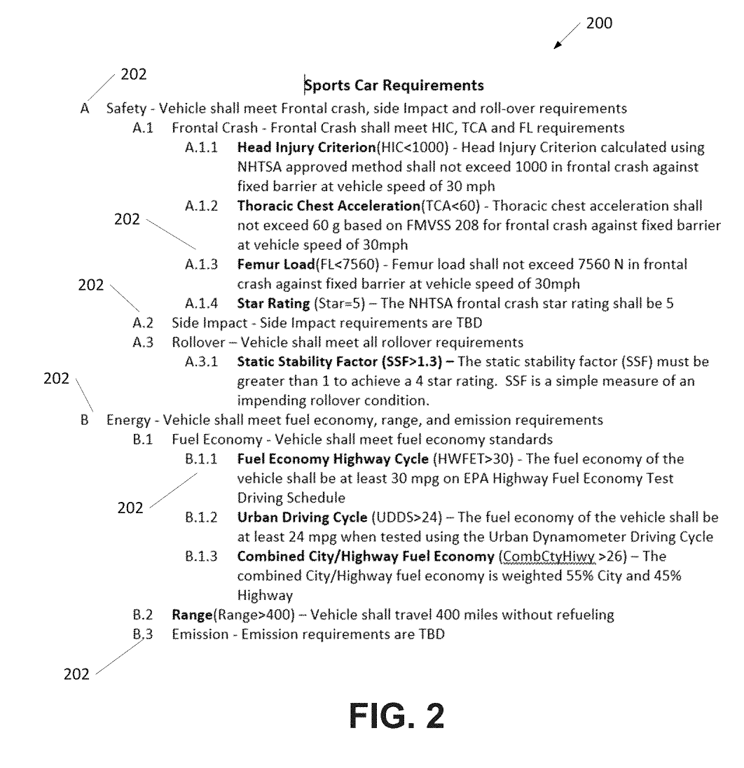

Text data may describe the system content in a structured form. FIG. 2 illustrates text data 200 that may represent example requirements for a system, such as a sports car system. These requirements may be grouped into a number of major level 1 categories, e.g., generate energy, store energy, and quality, reliability, and durability (QRD). The major categories may be further decomposed into level 2 requirements. Decomposition can reach more or fewer levels. Some categories may have more levels than others.

A word processing application may automate the creation of headings 202, e.g., A, A.1, B, B.1, etc. The Microsoft WORD® word processing environment, for example, provides a default template that automatically creates the heading and indents the text. The user may provide the content.

The Microsoft WORD® word processing environment and/or the Microsoft EXCEL® spreadsheet environment may use formatted text to improve readability. Other document formats may include extensible markup language (XML), which may be more difficult to prepare and read, but can be processed by a computer much faster than a document in a Microsoft WORD® format. For a document that describes the content of a large system, using XML may facilitate processing of the document.

A database management system (DBMS) that stores structured data may export structured data in a user-defined format, e.g., as a Microsoft WORD® document. An implementation may be able to read such exported data. A Microsoft WORD® document may allow for indirect communication with a DBMS. The program may directly access the DBMS and, through a query, obtain the various pieces of information needed for drawing a hierarchical diagram. For example, structured data may be received directly from a database.

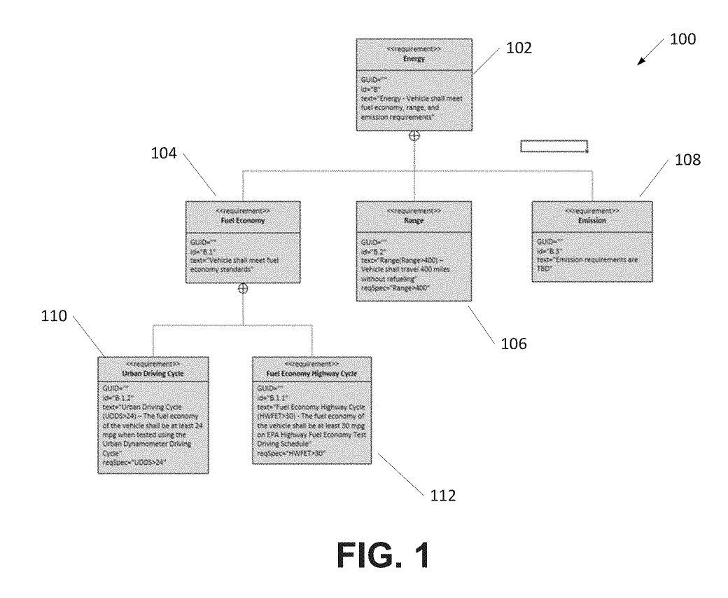

The examples shown in FIGS. 1 and 2 show the decomposition of requirements into sub-categories and eventually to individual requirement items. Accordingly, the disclosed subject matter may be used to create hierarchical requirements diagrams. The disclosed subject matter may be applicable to other types of entities. For example, material involved in building a house may be classified in different ways. One possibility is by parts of the house, e.g., roof, walls, floors, etc.

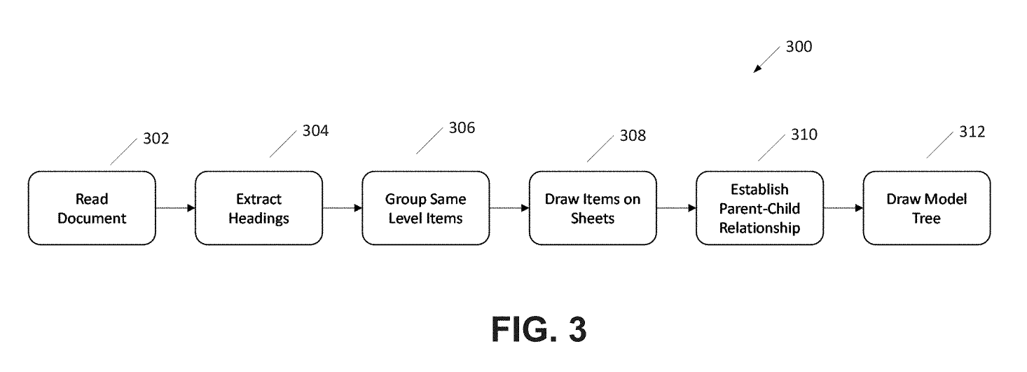

FIG. 3 illustrates an example process 300 for creating a hierarchical diagram. At 302, data representing the system contents may be read into a computer memory. For an API used with the Microsoft WORD® word processing environment, for example, the system contents may be wrapped into an object model that may include, e.g., paragraphs, with each paragraph representing an item of the hierarchy, and the like. An item may have a heading, e.g., B.1.2, followed by text. For drawing a node in a hierarchical diagram, a title may be used, e.g., “Fuel Economy” or “Range.” An object model used in the Microsoft WORD® word processing environment may not include a title. The title for a node may be determined, for example, by parsing the line. The title may be included in a set of delimiters, such as [Fuel Economy] or {Fuel Economy}, for example.

The read data may be parsed at 304 to determine one or more elements, which may represent items in a hierarchy of the system. Elements may include, for example, headings in a Microsoft WORD® document, tags in an XML document, and the like. Parsing XML for headings may be considerably easier because one can make use of XML tags. Furthermore, some XML readers may provide an object model that mirrors the hierarchy of the system contents. For example, each node in the XML object model, except for the top-level node, may be a child of another XML node, and a node may have children and siblings.

Whichever reader is used to parse the content document, the elements may be extracted. The elements may be used for programmatic creation of hierarchical diagrams.

At 306, items of the same level may be grouped and stored in a data structure, such as an array. For example, in the case of a word processing document, items with headings A, B, C, etc. may be assigned to a top-level group, e.g., level 1. Items with headings A.1, B.1, C.1, A.2, etc. may be assigned to a level 2 group. When grouping is performed to the lowest level (e.g., highest-numbered level), all items may be processed.

At 308, a top-level group may be drawn in one sheet. When diagrams are drawn using Microsoft EXCEL® as an electronic canvas, the term “sheet” may refer to a worksheet, which may also be referred to as a tab. A sheet may be one in a collection of electronic canvases or screens on which diagrams may be displayed. The top-level group may have no parent node. A user selected name, for example, a project name, may be assigned to be the top of the hierarchy. Level 2 nodes may be drawn on a parent-by-parent basis with siblings of a common parent drawn on one sheet. For example, nodes A.1, A.2, A.3 . . . may be drawn on one sheet as children of A. Nodes B.1, B.2, . . . may be drawn on another sheet as children of B. Items A.1.1, A.1.2, A.1.3 may be drawn on their own sheet as children of A.1. The items may be stored in a dynamic storage, e.g., an array or dictionary, until the entire hierarchy is processed. A practitioner skilled in the art will have little difficulty in implementing the processing steps.

Parent-child relationships among the items may be established or determined at 310. The relationships may be determined, for example, from the elements in the received and parsed data. For example, an item corresponding to a heading A may be determined to have a parent-child relationship with items corresponding to headings A.1, A.2, A.3, etc., and items corresponding to headings A.1.1, A.1.2, A.1.3, etc. may be determined to have a parent-child relationship to the item corresponding to heading A.1.

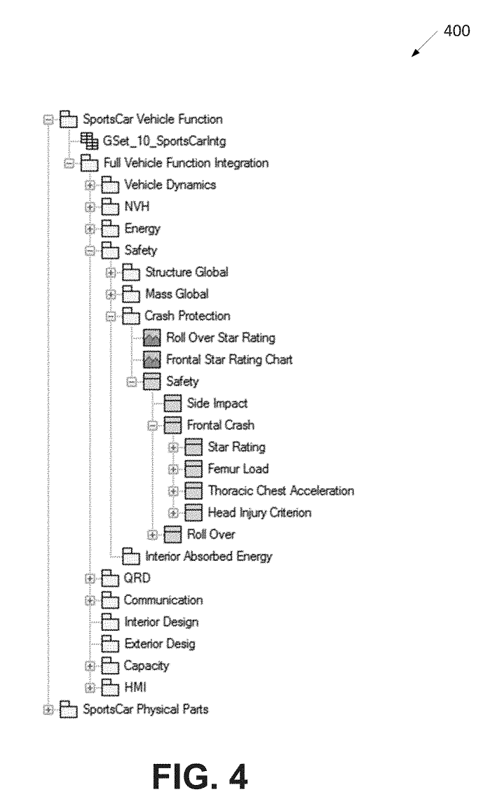

At 312, a model tree may be drawn. The model tree may mirror the item hierarchy. This may be advantageous for even a small system with just a few sheets of diagrams. The model tree may provide a summary view of the system. The model tree may help a user navigate the system hierarchy. FIG. 4 illustrates an example model tree 400 that may be used in decomposition of functional requirements of a system, e.g., a sports car system. Color-coded icons may indicate item type. As shown in FIG. 4, Safety Requirements may be a part of Full Vehicle Function Integration. A Safety Requirements item may have as sub-requirements Side Impact, Frontal Crash, and Roll Over.

The model tree 400 may be created after the diagrams are constructed. Shapes may be drawn on one or more, e.g., all sheets. Parent-child relationships may be established between two or more, e.g., all items in the hierarchy. Different sheets may represent parts, use cases, activities, and the like. A treeview or a similar control that displays hierarchical items may be used to draw the model tree 400. Parent-child relationships may be represented in a diagram in a variety of ways.

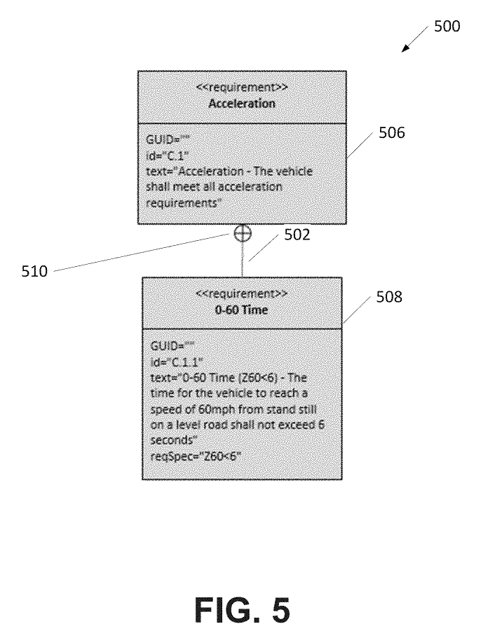

A parent-child relationship may be indicated with a containment path. FIG. 5 illustrates an example containment path 500. The containment path 500 may include a line 502 connecting a parent node 506 and a child node 508 with a solar cross 510 attached to the parent node 506.

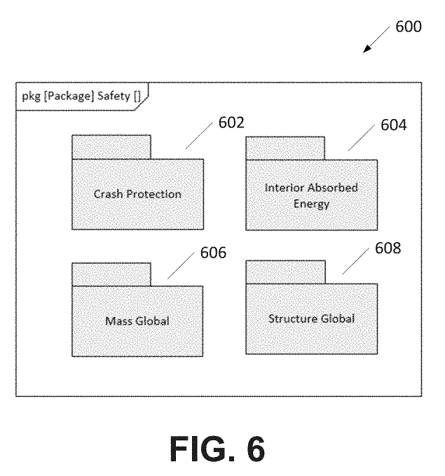

FIG. 6 illustrates an example shape or frame 600 that can be used to form an enclosure to indicate a parent-child relationship. The example frame 600 may be a Safety frame representing a Safety entity. Shapes 602, 604, 606, 608 represent Crash Protection, Interior Absorbed Energy, Mass Global, and Structure Global entities, respectively. These entities are children of the Safety entity; this parent-child relationship is indicated by enclosing shapes 602, 604, 606, 608 within frame 600.

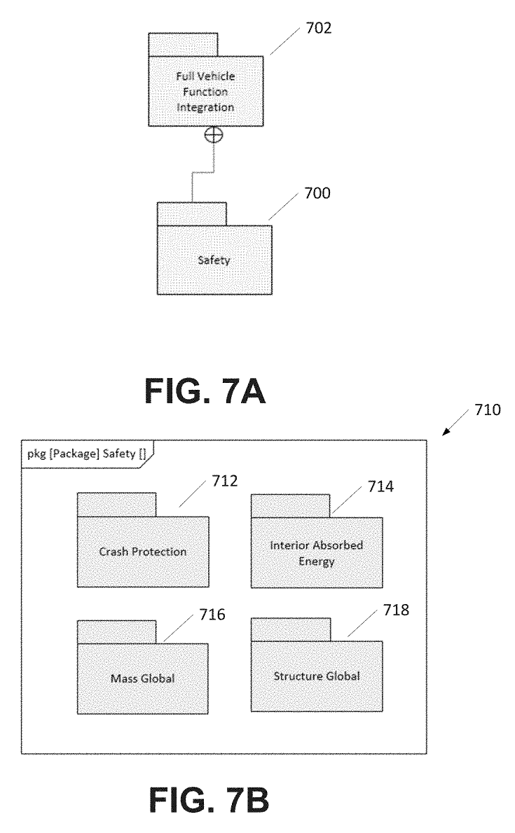

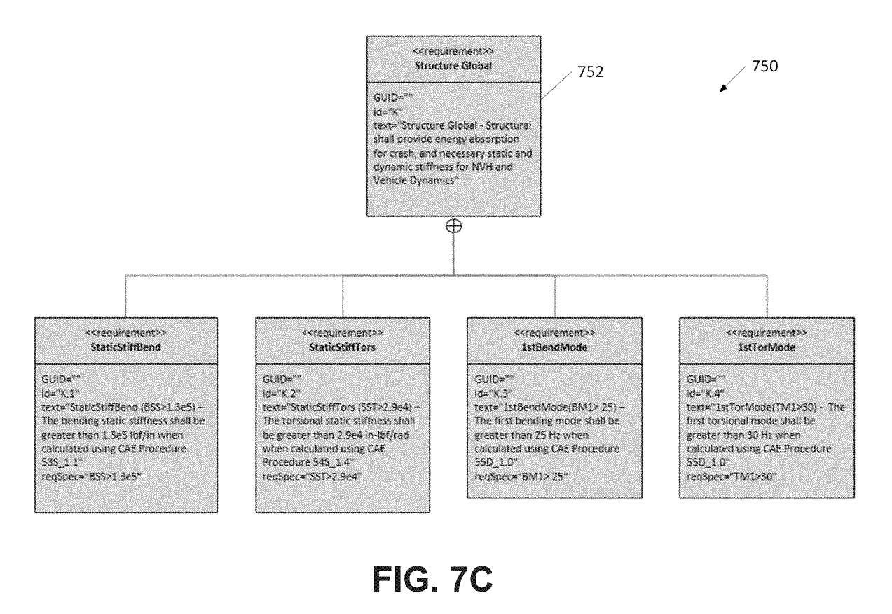

A name or names may be used to indicate a parent-child relationship. FIGS. 7A, 7B, and 7C illustrate the use of names to indicate parent-child relationships. As shown in FIG. 7A, a package icon 700, which may represent a Safety entity, may be by containment a child of a Full Vehicle Function Integration entity, which may be represented by an icon 702. In FIG. 7B, a frame 710 is assigned the name Safety. The frame 710 may contain shapes 712, 714, 716, 718, which may represent Crash Protection, Interior Absorbed Energy, Mass Global, and Structure Global entities, respectively.

A naming convention may provide that the Safety package icon 700 represents the same entity as the frame 710 because the icon and the frame have the same name. Because they represent the same entity, the items Crash Protection, Interior Absorbed Energy, Mass Global and Structure Global are, by deduction, children of the Safety package icon 700.

FIG. 7C illustrates an example hierarchy tree 750. A shape 752, representing a Structure Global entity, appearing at the top of the hierarchy tree 750 may be, by naming convention, a child of the package icon 718 representing the Structure Global entity in FIG. 7B. By deduction, a 1stBendMode entity is a grandchild of the Safety entity and a great grandchild of the Full Vehicle Function Integration entity.

Diagrams that depict parent-child relationships among entities may be used in the process of automatically or programmatically creating hierarchical diagrams. Such diagrams may be rendered on separate sheets in a spreadsheet environment. For example, the package icon 700 of FIG. 7A may be drawn at a top or first level. The frame 710 of FIG. 7B may be drawn at a second level. The hierarchy tree 750 of FIG. 7C may be drawn at a third level.

Accordingly, techniques for representing or establishing parent-child relationships may be used for creating a model tree. Diagrams for different levels may be drawn on the same sheet or on different sheets of a spreadsheet environment.

The model tree may be used for navigation. For example, when a node of the model tree 400 of FIG. 4 is clicked on, the program may display the corresponding sheet and may highlight the corresponding item. A practitioner skilled in the art will have little difficulty trapping the button click event and causing the program to execute the necessary steps.

The processes described herein may be implemented in a computer program, software, and/or firmware incorporated in a computer-readable medium for execution by a computer and/or processor. Examples of computer-readable media include, but are not limited to, computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs).

What is claimed:

1. A method of creating a hierarchical diagram representing a system comprising a plurality of components, the method comprising:
using a processor to receive data relating to the system;
parsing the received data to determine a plurality of elements representing the components;
associating respective levels in a hierarchy to the determined elements and the components;
providing an electronic canvas and a plurality of shape objects within the electronic canvas based on the hierarchy, the shape objects representing the components;
determining parent-child relationships between the components of the system represented by the shape objects; and
using the electronic canvas to define connections between the shape objects that represent the determined parent-child relationships.

2. The method of claim 1, the received data comprising at least one of text data, extensible markup language (XML) data, data in a user-defined format, or structured data received from a database.

3. The method of claim 1, wherein parsing the received data comprises parsing a plurality of extensible markup language (XML) tags.

4. The method of claim 1, further comprising associating elements having a same associated level in the hierarchy with a group.

5. The method of claim 4, further comprising associating the elements in the group with a data structure.

6. The method of claim 1, wherein shape objects representing components at a same level in the hierarchy are drawn on a same page of the electronic canvas.

7. The method of claim 1, wherein using the electronic canvas to define connections between the shape objects comprises generating a model tree.

8. The method of claim 1, wherein using the electronic canvas to define connections between the shape objects comprises generating a containment path.

9. The method of claim 1, wherein using the electronic canvas to define connections between the shape objects comprises generating a frame.

10. The method of claim 1, wherein the parent-child relationships between the components of the system are determined based on a naming of the shape objects.

11. A processor-readable storage medium storing processor-readable instructions that, when executed by a processor, cause the processor to:
receive data relating to a system comprising a plurality of components;
parse the received data to determine a plurality of elements representing the components;
associate respective levels in a hierarchy to the determined elements and the components;
provide an electronic canvas and a plurality of shape objects within the electronic canvas based on the hierarchy, the shape objects representing the components;
determine parent-child relationships between the components of the system represented by the shape objects; and
use the electronic canvas to define connections between the shape objects that represent the determined parent-child relationships.

12. The processor-readable storage medium of claim 11, the received data comprising at least one of text data, extensible markup language (XML) data, data in a user-defined format, or structured data received from a database.

13. The processor-readable storage medium of claim 11, storing further instructions for parsing the received data comprises parsing a plurality of extensible markup language (XML) tags.

14. The processor-readable storage medium of claim 11, storing further instructions for associating elements having a same associated level in the hierarchy with a group.

15. The processor-readable storage medium of claim 14, storing further instructions for associating the elements in the group with a data structure.

16. The processor-readable storage medium of claim 11, wherein shape objects representing components at a same level in the hierarchy are drawn on a same page of the electronic canvas.

17. The processor-readable storage medium of claim 11, wherein using the electronic canvas to define connections between the shape objects comprises generating a model tree.

18. The processor-readable storage medium of claim 11, wherein using the electronic canvas to define connections between the shape objects comprises generating a containment path.

19. The processor-readable storage medium of claim 11, wherein using the electronic canvas to define connections between the shape objects comprises generating a frame.

20. The processor-readable storage medium of claim 11, wherein the parent-child relationships between the components of the system are determined based on a naming of the shape objects.
